(19) United States
(12) Patent Application Publication
(10) Pub. No.: US 2011/0260694 A1
(43) Pub. Date: Oct. 27, 2011

(54) BUILT-IN CHARGER

(76) Inventors: Jordan T. Bourilkov, Stamford, CT (US); David C. Batson, Winchester, MA (US); George M. Cintra, Holliston, MA (US); Alexander Kaplan, Providence, RI (US); David N. Klein, Southbury, CT (US); Leslie J. Pinnell, Framingham, MA (US); John Rotondo, Trumbull, CT (US)

(21) Appl. No.: 12/766,353

(22) Filed: Apr. 23, 2010

(51) Int. Cl. H02J 7/04; H02J 7/00

(52) U.S. Cl. 320/157; 320/162; 320/160

(57) ABSTRACT

Disclosed is a dual use apparatus including a base device having a port for delivering charging current to an battery to be charged, and a charging circuit, disposed in the base device and in communication with the port to determine a charge capacity of the battery using battery identifying information received from the battery, and applying the charging current to the battery based on the determined charge capacity.

### BACKGROUND

This disclosure relates to a built-in charger. Batteries are charged by a source that provides a constant current followed by a constant voltage (CC/CV) with a crossover from constant voltage to constant current depending on the battery chemistry, which for Lithium-ion rechargeable batteries is at approximately 4.2V. To charge a rechargeable battery within a given period of time, and to avoid damage to the battery due to the application of incorrect charging current, a battery charge algorithm carefully and accurately regulates the charging device's charging mechanism. Different types of rechargeable batteries have different capacities that require different levels of charging currents. Accordingly, the algorithm may collect information regarding the rechargeable battery's capacity to enable completion of the charging operation within a specified period of time and to avoid damaging the rechargeable battery.

### SUMMARY

By way of example, a Universal Serial Bus (“USB”) port on the laptop or desktop computer may provide power to an electronic appliance and charges rechargeable batteries in the appliance. The electronic appliance would need to control the charging algorithm to ensure that its rechargeable batteries are not damaged. Further, the charging current though a USB port is typically limited to a small current, e.g., 500 mA. As a result, charging through USB ports may take a long time. In the event the user has not planned ahead and made sure the appliance batteries are charged and ready to go, the time to recharge the batteries can make the appliance unavailable at the time needed.

In general, in one aspect, a dual use apparatus includes a base device having a port for delivering charging current to an battery to be charged, and a charging circuit, disposed in the base device and in communication with the port to determine a charge capacity of the battery using battery identifying information received from the battery, and applying the charging current to the battery based on the determined charge capacity.

This aspect may include one or more of the following features.

The port delivers the charging current to the battery until a predetermined charge level at the battery is reached within a predetermined time. The predetermined charge level is at least 90% of the charge capacity of the battery, and the predetermined time is less than about 15 minutes. The predetermined charge level is at least 90% of the charge capacity of the battery, and the predetermined time is in a range of 5 to 15 minutes.

In an implementation, the port can deliver a charging current greater than at least 500 mA to the battery. In some examples, the port can deliver a charging current of at least 15A to the battery.

The charging circuit periodically adjusts a magnitude of the charging current after a predetermined voltage level at terminals of the battery is reached to maintain the voltage between the terminals at the battery at the predetermined voltage level. The charging current is terminated after the predetermined time.

The battery is embedded within an electronic appliance. The base device includes a connector for coupling to the port an electronic appliance having a battery. The connector can be a universal connector capable of connecting to different types of electronic appliances.

The connector can include a 5-pin unipolar connector. The 5-pin unipolar connector can include a reversible connector having charging pins and at least one identifying pin.

In another aspect, a dual use apparatus includes a base device having a housing, a charging circuit to determine capacity of a battery to be charged based on identifying information received from the battery, and apply a charging current to the battery based on the information, a compartment portion of the housing of the base device for receiving the charging circuitry, the compartment having terminals for communicating with the charging circuit, and a charging port, connected to the charging circuitry, for communication with the battery. Examples of this aspect may include a charging port that is supported by and located on the housing of the base device.

Some advantages of the apparatus are as follows. The charging port, and the high charge rate cable and connector are universal fast charge rate equipment that allows different appliances to be connected to the same charging port, thus eliminating a need for multiple chargers when traveling. The appliances are charged quickly, i.e., with 5 to 15 minutes thus making the appliances almost immediately available after charging. The high charging current, e.g., greater than at least 500 mA, provides an ability to charge high charge-rate devices quickly.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A and 1B are schematic diagrams of example dual-use apparatuses or devices with built-in charging circuits.

FIGS. 2 and 3 are schematic diagrams of example built-in charging circuit arrangements.

FIG. 4 is a view of an example docking station to receive a battery-operable appliance.

### DETAILED DESCRIPTION

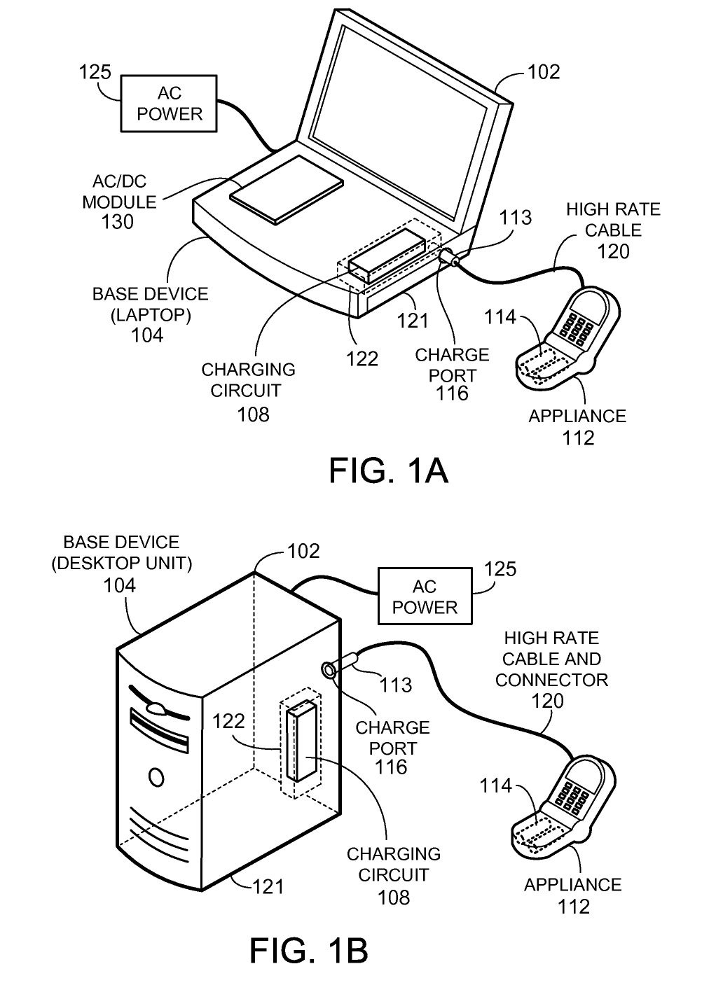

Referring to FIGS. 1A-B, a base device 104, e.g., a laptop or a desktop unit, that includes a charging circuit 108 for delivering charging current to one or more rechargeable batteries 114 in an electronic appliance 112 is shown. Described herein will be a unique class of apparatuses, here termed as “dual use apparatus,” (e.g., apparatus 102) which includes the base device 104 that has in addition to one or more regular purposes, the ability to charge other appliances 112 (that include rechargeable batteries 114) while fulfilling its regular purposes. For example, the dual use apparatus 102 of FIG. 1A can function as a laptop computing device and also charge one or more appliances 112. The charging circuit 108 delivers charging currents up to, e.g., 6 A for charging the batteries 114 as described in detail below. In a laptop or a desktop unit, the charging circuit 108 can have similar power requirements as the laptop or desktop unit's other internal components. For example, the internal components in the laptop or desktop unit may be rated at 12V, 5V, or 3.3V. A charging circuit 108 implemented as, for example, a LiFePO4 battery charging circuit, is typically rated at 3.9V. Because of the similar power requirements, in a dual-use apparatus 102, the charging circuit 108 can be added to the base device 104 by minimal modification of the internal circuitry in the base device 104. For example, a DC-DC step down converter that is capable of stepping down 5V to the 3.9V needed by the LiFePO4 battery charging circuit can be added to the internal circuitry of the base device 104.

The charging circuit 108 delivers a charging current to the appliance 112 through a charging port 116 on the base device 104. As shown, the appliance 112 is connected to the charging port 116 through, e.g., a (male or female) connector 113 and a high charge rate cable 120. In some implementations, the charging port 116 includes a 3-pin output female (or male) connector having e.g., two power pins and an identification pin. The charging port 116 is located, for example, on the computer backplane for connection with the high charge rate cable 120. In some examples, the charging port 116 includes a 5-pin unipolar connector.

Alternatively, the charging port 116 can be implemented as a charging dock that includes contacts for connecting the terminals in the charging port 116 to the battery 114 in the appliance 112. In some implementations, the battery terminals can be directly exposed to the docking station contacts to minimize any resistance between the charger circuit 108 output and battery 114. A battery ID can also be used to prevent charging regular low-rate Li-ion batteries with excessive current.

In the examples described below, the appliance 112 can be any electronic device having one or more electrochemical batteries 114. For example, the appliance 112 can be any of e.g., a portable digital camera, a personal digital assistant, or a cell phone. In some implementations, the appliance 112 can be an external battery holder configured to deliver charging current from the charging circuit 108 to the battery 114.

The charging circuit 108 is an analog and/or digital controlled charging circuit. In some examples, the charging circuit 108 is an ultra-high power charging circuit that is capable of delivering a charging current of more than at least 500 mA through the charging port 116 and the high charge rate cable 120. In some examples, the charging circuit 108 is capable of delivering a charging current of up to at least up 15A through the charging port 116 and through the high charge rate cable 120. For example, the charging circuit 108 can provide a charging current The charging circuit 108 can be any circuit for charging electrochemical cells. An example charging circuit 108 can be any one of the charging circuit described in co-pending U.S. application Ser. No. 11/776,021, entitled “Fast Battery Charger Device and Method,” and co-pending U.S. application Ser. No. 11/776,261, entitled “Ultra Fast Battery Charger with Battery Sensing,” the contents of which are incorporated herein in their entirety.

In one implementation, the dual-use apparatus 102 includes a base device 104 having a housing 121. The housing can include a compartment portion 122. The charging circuit 108 is configured to be received in the compartment 122, and is separable from the base device 104. That is, the charging circuit 108 can be removed and swapped as a customer replaceable unit (CRU) or a field replaceable unit (FRU). The compartment 122 has terminals (not shown) that provide AC power from an external AC source 125 to the charging circuit 122. In other examples, the charging circuit 108 is integrated into the circuitry of the base device 104 and is not separable from the base device 104.

The battery 114 include secondary electrochemical cells (or batteries) cells. There are two types of cells. Primary electrochemical cells are meant to be discharged, e.g., to exhaustion, only once, and then discarded. Primary cells are typically not intended to be recharged. Primary cells are described, for example, in David Linden, Handbook of Batteries (McGraw-Hill, 2d ed. 1995).

Secondary electrochemical cells can be recharged many times, e.g., more than fifty times, more than a hundred times, or more. In some situations, secondary cells include relatively robust separators, such as those having many layers and/or that are relatively thick. Secondary cells can also be designed to accommodate for changes, such as swelling, that can occur in the cells. Secondary cells are described, e.g., in Falk & Salkind, “Alkaline Storage Batteries”, John Wiley & Sons, Inc. 1969 and U.S. Pat. No. 345,124; both hereby incorporated herein by reference. In the embodiments described herein, the battery 114 includes secondary, or rechargeable, batteries.

The battery 114 includes Li-Ion cells having graphitic anode material or lithium titanate anode material, and lithiated-iron-phosphate cathode materials adapted to enable fast recharge of rechargeable batteries based on such materials. In some examples, the charging circuit 108 is further configured to charge different types of batteries 114, including, for example, cylindrical batteries, prismatic batteries, and/or button-cell batteries.

The base device 104 can be any electronic device that is powered by an AC power source 125 at least for part of its operation, e.g., a source providing power at a rating of 85V-265V and 50 Hz-60 Hz, supplying an internal AC/DC module 130. The AC/DC module 130 converts the AC power to a low DC voltage (e.g., 5-24V) and e.g., feeds this low DC voltage to, e.g., a DC-DC converter to provide a level suitable for powering the internal circuits of the base device 104. In addition to being powered by the AC/DC module 130, the base device 104 is also typically powered by one or more electrochemical cells (not shown) when the device 104 is not connected to the power source 125.

A single charge port 116 on the base device 104 can be configured to provide charging currents to multiple appliances 112 by deriving two or more additional ports from the single charge port 116 for connecting the appliances 112. Alternatively, the base device 104 can include multiple charge ports 116 to provide charging currents to multiple appliances 112 simultaneously. The charge port 116 can be supported by and e.g., located on the housing 121 of the base device 104.

In addition to supplying a charging current to the appliance 112, the high charge rate cable 120 may also provide operating power, e.g., DC power needed to operate the appliance 112. For example, a portable music device, e.g., an MP3 player, can draw operating DC power from the AC/DC module 130 in the base device 104 through the high charge rate cable 120.

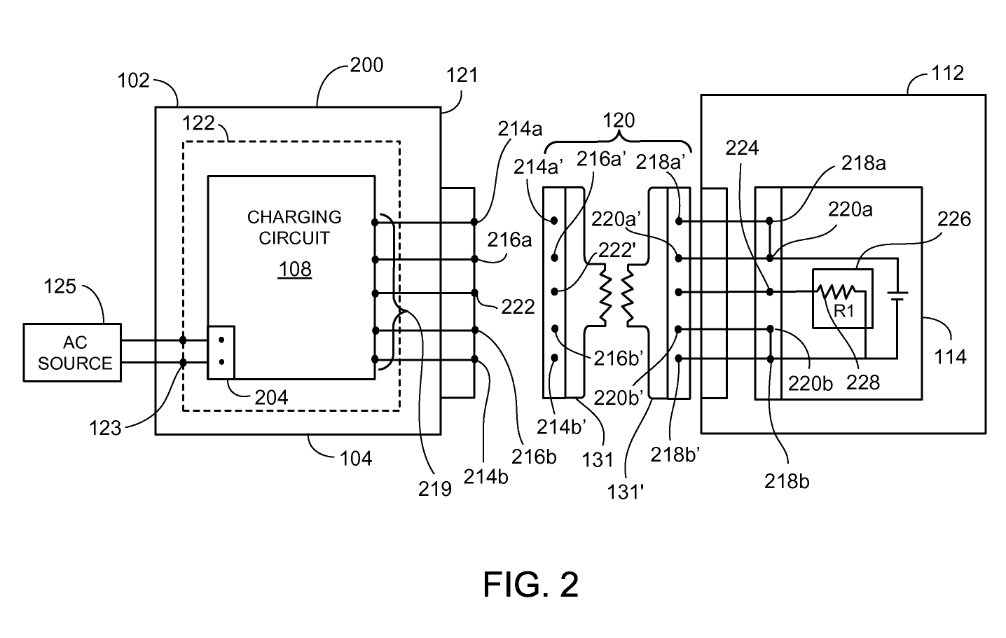

Referring now to FIG. 2, an example dual-use apparatus 200 includes a base device 104 having a charging circuit 108. The dual-use apparatus 200 is coupled to an appliance 112 through a charging port as shown. The charging circuit 108 is configured to be received in a compartment 122 in the base device 104. The AC source 125 is connected to terminals 123 in the compartment 122, which are in turn connected to the AC power port 204 on the charging circuit 108. Charging terminals 214a and 214b of the charging circuit 108 are electrically and mechanically coupled to battery power terminals 218a and 218b, respectively, of a battery 114 in the appliance 112 through the high charge rate cable 120 having connectors 131, 131′. Sensing terminals 216a and 216b are electrically and mechanically coupled to the battery sensing terminals 220a and 220b, respectively, of the battery 114 in the appliance 112 through the high charge rate cable 120 and connectors 131, 131′. The terminals 214a, 214b, 222, 216a, and 216b located on the base device 104 are electrically and mechanically coupled to like terminals 219 on the charging circuit 108.

The terminals 218a, 218b, 224, 220a and 220b are pins adapted to be connected in a mating configuration with respective terminals 218a′, 218b′, 224′, 220a′ and 220b′ located in the connector 131′. Likewise, the terminals 214a, 214b, 224, 216a and 216b are pins adapted to be connected in a mating configuration with respective terminals 214a′, 214b′, 224, 216a′ and 216b′ located in the connector 131. In some examples, the terminals 218a and 218b (as well as 220a, 220b, and 224) can be electrically and mechanically connected to corresponding terminals on a (male or female) connector (not shown) located on the appliance 112. As such, in some examples, the connector 131′ can be connected to the connector on the appliance 112.

The charging circuit 108 determines an appropriate charging current to be applied to the battery 114 and applies that charging current through charging terminals 214a and 214b to the terminals 218a and 218b of the battery 114.

In an implementation, a voltage sensor (not shown) is electrically coupled to the sensing terminals 216a and 216b at the base device 104. The voltage sensor measures the voltage at the battery sensing terminals 220a and 220b, which correspond to the voltage at the battery power terminals 218a and 218b of the battery 114. Based on the measured voltage, the charging circuit 108 makes one or more adjustments to the charging voltage and/or current applied to the battery 114 so that the charging circuit 108 completes charging the battery 114 in accordance with a predetermined charging profile for the battery 114, e.g., achieve 80-90% charge capacity in less than 15 minutes.

As described above, the charging circuit 108 charges batteries 114 having different capacities. The charging circuit 108 applies different levels of charging currents according to a capacity of a rechargeable battery 114. In this regard, the charging circuit 108 includes a capability of determining the capacity of the battery 114 that is connected to the charging circuit 108. Based on the determined battery capacity, the charging circuit 108 determines a current level to be applied to the battery 114 such that a pre-determined charge (e.g., 90% capacity) for the battery 114 can reached within a predetermined time (e.g., approximately 5 minutes). To achieve this charging performance, charging currents corresponding to approximately 10-15C are required, where 1C is a charge rate that corresponds to a charging current that would result in the rechargeable battery 114 being charged in 1 hour, whereas 12C is a charge rate that corresponds to a charging current that would result in the rechargeable battery 114 being charged in 5 minutes (i.e., 1/12^{th} of an hour.)

Typically, the capacity of a rechargeable battery 114 is in a range of 50 mAh to 3Ah, where “Ah” is the unit of battery capacity Ampere-hour. Other capacities can be accommodated. Thus, for example, to charge a 500 mAh capacity battery to greater than 90% of full capacity at a charge rate of 12C (i.e., in approximately five minutes), a charging current of approximately 6A is required to (i.e., 6A* 1/12 hours=500 mAh.) On the other hand, to charge a 700 mAh battery with a charge rate of 12C, a charging current of approximately 8.5A is required.

The charging circuit 108 is also configured to control the charging process. Such control can include e.g., regulating the voltage and/or current applied to the battery 114. For example, the charging circuit 108 can be configured to ensure that the battery 114 is charged to its predetermined charge level within a certain time period. Also, the charging circuit 108 can be configured to ensure that the battery's voltage does not exceed a predetermined upper voltage limit. In some examples, the charging circuit 108 may also be configured to ensure that the voltage increase rate, i.e., the rate at which the voltage at the charging terminals of the battery 114 increase as the charging operation progresses, conforms to a specified charging profile (e.g., the charging rate is programmed to increase at a predetermined rate for the first few minutes of the charging operation.)

Control of the charging process requires monitoring the voltage at the battery power terminals 218a and 218b. However, because the base device's 104 charging terminals 214a and 214b have a non-negligible resistance, a voltage sensing device coupled to the charging terminals 214a and 214b would include an error generated by a voltage drop at the charging terminals 214a and 214b. To reduce the effect of voltage measurement inaccuracies, a separate dedicated set of terminals, i.e., sensing terminals 216a and 216b, are provided to measure the battery's 114 voltage. The sensing terminals 216a and 216b of the charger 10 are different from the charging terminals 214a and 214b of the base device 104 providing different charging and voltage sensing paths between the battery and the charging circuit 108 to reduce voltage measurement errors when measuring the voltage of the battery 114. The battery power terminals 218a and 218b are in electrical communication with the battery sensing terminals 220a and 220b. Accordingly, the voltage measurement at the sensing terminals 216a and 216b corresponds to the voltage at the battery power terminals 218a and 218b.

In some examples, an additional terminal, i.e., identifying terminal 222, can be used to determinate the capacity of and/or other relevant information regarding the battery 114. The identifying terminal 222 is mechanically and electrically coupled to a corresponding battery identifying terminal 224. The battery identifying terminal 224 is in electrical communication with an identification mechanism 226 in the battery 114. The identification mechanism 226 provides the charging circuit 108 with identification information representative of the battery's capacity, type, model, and/or other data germane to the charging operation to be performed on the rechargeable battery 12. Based on the identification information received from the battery 12, the charger 10 determines the charging current to apply to the battery 12.

One example of a battery identification mechanism 226 is a battery identifying resistor 228 that has a resistance value representative of a corresponding capacity, type, and/or model of the battery 114. The identifying resistor 228 can be disposed in the interior of the casing of the battery 114, or on the exterior of the battery 114.

The identifying resistor 228 is electrically coupled to the battery power terminal 218b and the battery sensing terminal 220b of the battery 114. Upon applying a current or voltage to the battery identifying terminal 224 of the battery 114 from the terminal 222 of the base device 104, a closed electrical path between the terminals 218b and 224 of the battery 114 is formed, resulting in the flow of electrical current through the identifying resistor 228. To obtain information representative of the battery's capacity and/or identity, a pre-determined test current, Iₜₑₛₜ, is applied by the charging circuit 108 to the identifying resistor 228. A voltage drop, V_{R1}, across the identifying resistor 228 is measured using a voltage sensor coupled to the terminal 222. The measured voltage drop at the identifying resistor 228 is communicated to the charging circuit 108, which uses the measured voltage to compute the resistance of the identifying resistor 226 according to the relation R1=V_{R1}/Iₜₑₛₜ.

The computed resistance R1 corresponding to the ID resistor 26 can then be used as a key to access a lookup table that holds for each of a plurality of different resistance values associated data regarding battery types and capacities. Such data may also include permissible charge current values to apply to the battery, and/or other information that may be germane to the charging process. Alternatively, the measured voltage V_{R1} may be used to access the lookup table. In some embodiments, the identifying resistor 228 is a thermistor whose resistance varies with changing temperature. Such an identifying thermistor can thus be used to both identify the type of battery to be charged and to monitor the battery's temperature.

Other types of battery identification mechanisms may be employed. Suitable battery identification mechanisms may include Radio Frequency Identification (RFID) mechanisms in which in response to an activation signal (e.g., a radio signal), an RFID device communicates to the charger 10 an electrical signal representative of the battery's capacity, type, state of the battery's charge/health, etc. Other suitable identification mechanisms include mechanisms that implement serial communication techniques to identify the battery, e.g., the Smart Battery SMBus standards to cause identification data representative of the battery's capacity and/or type to be communicated to the charging circuit 108 via a serial data communication interface. In some embodiments, determination of the charging current may be performed by measuring at least one of the battery's electric characteristics indicative of the capacity and/or type of battery (e.g., the battery's DC charging resistance.) A detailed description of an exemplary charger device that adaptively determines the charging current based on measured characteristics of the battery is provided in co-pending U.S. application Ser. No. 11/775,987 entitled “Adaptive Charger Device and Method”, the contents of which are incorporated herein by reference in their entirety.

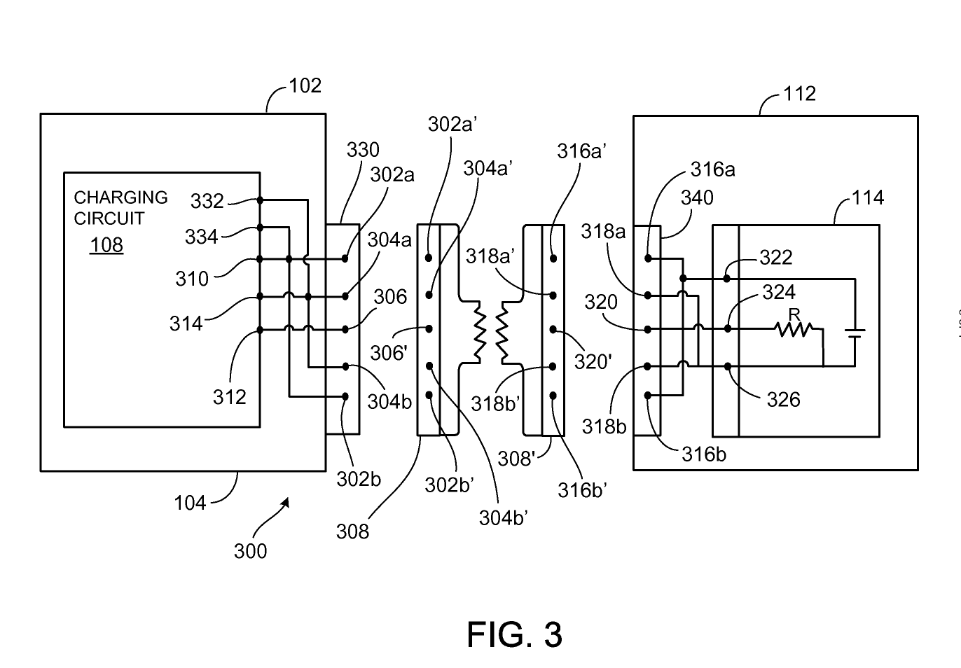

Referring to FIG. 3, an exemplary connector arrangement 300 is shown. In this arrangement 300, terminals 302a, 304a, 306, 304b, and 302b are pins adapted to be connected in a mating configuration with respective terminals 302a′, 304a′, 306′, 304b′, and 302b′ located on the connector 308. The terminals 302a and 302b are connected to a first supply terminal 310 (e.g., a positive supply terminal) of the charging circuit 108, and terminals 304a and 304b are connected to a second supply terminal 312 (e.g., a negative supply terminal) of the charging circuit 108 (FIG. 1). The terminal 306 is connected to terminal 314 of the charging circuit 314, which is connected to sensing circuitry (not shown) within the charging circuit 108. In one example, the sensing circuitry in the charging circuit 108 senses or identifies a type of battery 114 in the appliance 112 as described above. On the appliance 112 side, terminals 316a, 318a, 320, 318b, and 316b are pins adapted to be connected in a mating configuration with respective terminals 316a′, 318a′, 320′, 318b′, and 316b′ located on the connector 308′. The terminals 316a and 316b are connected to a first battery terminal 322 (e.g., positive terminal) of the battery 114, and terminals 318a and 318b are connected to a second battery terminal 326 (e.g., negative terminal) of the battery 114. An ID resistor “R,” is connected to terminal 320 and functions are described above.

In some examples, sensing wires to measure a voltage across the battery 114 can be connected to terminals 302a and 304a on the back of the connector 330 on the base device 104, and further to sensor terminals 332 and 334 of the charging circuit 108. These sensor terminals 332 and 334 can be connected to, for example, a voltage sensor circuit as described above, implemented in the charging circuit 108.

The connectors 308, 308′ are reversible, i.e., the connectors 308, 308′ can provide power to the battery 114 with correct polarity voltage in either up or down positions that are rotated at 180 degrees from each other. One advantage of arrangement 300 is that the connectors 308 and 308′ can be connected to connectors 330, 340 on the base device 104 and the appliance 112 in any orientation without having to be concerned about matching respective terminals in the connectors. For example, the connector 330 can be connected such that terminals 316a′, 318a′, 320′, 318b′, and 316b′ correspond to terminals 316b, 318b, 320, 318a, and 316a, respectively.

In an implementation, on the appliance 112 side, the connector 308′ can have only 3 pins and still connect in any orientation to the connector 340 on the appliance 112. For example, terminals 316a′ and 318a′ may be left blank such that terminals 318b′ and 316b′ carry the full power. In some examples, terminals 318b′ and 316b′ may be left blank such that terminals 316a′ and 318a′ carry the full power. In some implementations, a similar configuration may be implemented with connectors 308 and 330. One advantage of having only 3 terminals in the connectors is that the high rate cable need only have 3 wires instead of 5 corresponding to the terminals of the connectors.

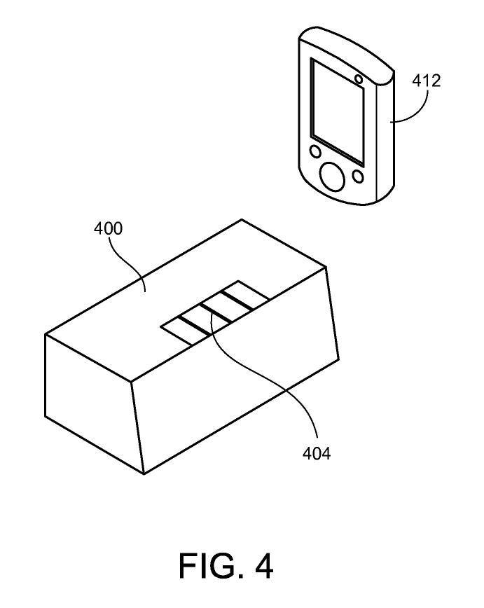

In some examples, the charging port 116 can be implemented as a docking station structured to receive the appliance 112 having the rechargeable battery 114. Referring to FIG. 4, an exemplary docking station 400 and a battery-operable appliance 412, such as a personal digital assistant (PDA), configured to be received in a mating configuration with the docking station 400, are shown. The docking station 400 includes terminals that are coupled to respective terminals disposed on the battery-operable appliance 412. The terminal connection

### OTHER EMBODIMENTS

A number of embodiments of the invention have been described. Nevertheless, it will be understood that various modifications may be made without departing from the spirit and scope of the invention. Accordingly, other embodiments are within the scope of the following claims.

1. A dual use apparatus comprising:
a base device including:
a port for delivering charging current to an battery to be charged, and
a charging circuit, disposed in the base device and in communication with the port to determine a charge capacity of the battery using battery identifying information received from the battery, and applying the charging current to the battery based on the determined charge capacity.

2. The dual use apparatus of claim 1 in which the port delivers the charging current to the battery until a predetermined charge level at the battery is reached within a predetermined time.

3. The dual use apparatus of claim 2 in which the predetermined charge level is at least 90% of the charge capacity of the battery, and the predetermined time is less than about 15 minutes.

4. The dual use apparatus of claim 2 in which the predetermined charge level is at least 90% of the charge capacity of the battery, and the predetermined time is in a range of 5 to 15 minutes.

5. The dual use apparatus of claim 1 in which the port delivers a charging current greater than at least 500 mA to the battery.

6. The dual use apparatus of claim 1 in which the port delivers a charging current of at least 15A to the battery.

7. The dual use apparatus of claim 1 in which the charging circuit periodically adjusts a magnitude of the charging current after a predetermined voltage level at terminals of the battery is reached to maintain the voltage between the terminals at the battery at the predetermined voltage level.

8. The dual use apparatus of claim 2 in which the charging current is terminated after the predetermined time.

9. The dual use apparatus of claim 1 in which the battery is embedded within an electronic appliance.

10. The dual use apparatus of claim 1 wherein the base device includes a connector for coupling to the port an electronic appliance having a battery.

11. The dual use apparatus of claim 10 in which the connector is a universal connector capable of connecting to different types of electronic appliances.

12. The dual use apparatus of claim 10 in which the connector includes a 5-pin unipolar connector.

13. The dual use apparatus of claim 12 in which the 5-pin unipolar connector includes a reversible connector having charging pins and at least one identifying pin.

14. A dual use apparatus comprising:
a base device having a housing;
a charging circuit to determine capacity of a battery to be charged based on identifying information received from the battery, and apply a charging current to the battery based on the information,
a compartment portion of the housing of the base device for receiving the charging circuitry, the compartment having terminals for communicating with the charging circuit, and
a charging port, connected to the charging circuitry, for communication with the battery.

15. The dual use apparatus of claim 14 in which the charging port is supported by and located on the housing of the base device.
